(19) United States
(12) Patent Application Publication
(10) Pub. No.: US 2018/0323676 A1
(43) Pub. Date: Nov. 8, 2018

(54) ELECTRIC MACHINE END TURN COOLING APPARATUS

(71) Applicant: PRIPPELL TECHNOLOGIES, LLC, Los Angeles, CA (US)

(72) Inventors: Wally E. Rippel, Altadena, CA (US); Eric E. Rippel, Los Angeles, CA (US)

(21) Appl. No.: 16/030,730

(22) Filed: Jul. 9, 2018

Related U.S. Application Data
(63) Continuation of application No. 14/857,033, filed on Sep. 17, 2015, now abandoned.
(60) Provisional application No. 62/052,369, filed on Sep. 18, 2014.

(51) Int. Cl. H02K 5/20

(52) U.S. Cl. CPC H02K 5/20

(57) ABSTRACT

A cooling structure for an end turn of an electric machine stator. The cooling structure includes a plurality of layers, a layer of the plurality of layers having an opening forming a portion of a fluid passage.

### CROSS-REFERENCE TO RELATED APPLICATION(S)

The present application is a continuation of U.S. patent application Ser. No. 14/857,033, filed Sep. 17, 2015, entitled “ELECTRIC MACHINE END TURN COOLING APPARATUS”, which claims priority to and the benefit of U.S. Provisional Application No. 62/052,369, filed Sep. 18, 2014, entitled “ELECTRIC MACHINE END TURN COOLING APPARATUS”; the entire content of both of the documents identified in this paragraph is incorporated herein by reference.

### FIELD

One or more aspects of embodiments according to the present invention relate to cooling of electric machines, and more particularly to a system for cooling an end turn in an electric machine.

### BACKGROUND

In non-brushed machines such as permanent magnet (PM) brushless DC machines and induction machines (IM), the stator may consist of a laminated core stack and a winding. In turn, the laminated core stack may include a plurality of axially directed slots through which electrical conductors are placed to form a structure referred to as a winding. The portion of the winding contained within the slots is termed the “active winding”, while the two end portions which lie outside the core are termed “end turns”. The end turns are elements which, together with the active winding, complete an electrical circuit. In themselves, the end turns do not contribute to energy conversion or torque production, but they do generate heat which is proportionate to the square of the current flow and hence approximately proportionate to the square of torque produced. For four-pole machines, each end turn may account for roughly 12% of the total machine loss.

For low-performance machines, winding current densities may be less than 400 A/cm². In these cases, heat produced in both the active winding and end turn may be relatively small and modest air flow directed over the stator housing and the end turns may provide sufficient heat transfer to limit temperatures to safe values. In high-performance machines, current densities may exceed 1000 A/cm², and end turn heat may be forced to flow into the active winding, raising the active winding temperature, while also causing the end turn temperature to rise well above that of the active winding. This may result in failure of the machine.

Thus, there is a need for an efficient system for end turn cooling.

### SUMMARY

According to an embodiment of the present invention there is provided a cooling structure including: a plurality of layers, a first layer of the plurality of layers having an opening forming a portion of a first fluid passage, and the structure being configured to cool an end turn of an electric machine.

In one embodiment, each layer is: a lamination, or a turn of a wound strip.

In one embodiment, any layer of the plurality of layers has: a first opening, a second opening, and a third opening, having the same size and shape, and being uniformly spaced along the layer.

In one embodiment, any layer of the plurality of layers has a first opening and a second opening, the first opening differing in shape and/or in size from the second opening.

In one embodiment, the first layer has a first opening and a second layer of the plurality of layers has a second opening, the first opening differing in shape and/or in size from the second opening.

In one embodiment, the structure is a hollow cylinder having: an inner or outer cylindrical surface, and/or an annular end surface, either or both of which are in thermal contact with the end turn.

In one embodiment, the structure is configured to cool an end turn of an axial gap electric machine.

In one embodiment, the plurality of layers includes a wound strip, each of the layers being one of a plurality of turns of the wound strip.

In one embodiment, the plurality of layers includes a first wound strip and a second wound strip, the second wound strip being co-wound with the first wound strip, and wherein each of the layers is a turn of the first wound strip or of the second wound strip.

In one embodiment, the structure includes the opening, the structure further including a manifold having a manifold channel in fluid communication with the plurality of fluid channels.

In one embodiment, the structure includes the opening, the structure further including a flow director configured to direct fluid flow into, or receive fluid flow from, a subset of the plurality of fluid channels.

In one embodiment, the plurality of layers includes a plurality of alternating different-sized openings.

In one embodiment, each of the openings overlaps two openings in another layer.

In one embodiment, the structure includes the opening, the structure further including a flow director configured to direct fluid flow into, or receive fluid flow from, a subset of the plurality of fluid channels.

In one embodiment, the flow director is one of the plurality of layers, and has a plurality of openings of a first size, wherein: one of the openings of the flow director is aligned with an opening of the first size of one of the plurality of layers, and another opening of the first size of the one of the plurality of layers is not aligned with any opening of the flow director.

In one embodiment, the structure includes a first manifold having a first manifold channel and a second manifold having a second manifold channel, wherein: each of the plurality of layers has a plurality of openings, the plurality of openings of the plurality of layers forms: a plurality of substantially azimuthal fluid passages in fluid communication with the first manifold channel and the second manifold channel, and a plurality of substantially axial fluid passages in fluid communication with the first manifold channel and the second manifold channel, or a plurality of substantially radial fluid passages in fluid communication with the first manifold channel and the second manifold channel, each substantially azimuthal fluid passage connects: a pair of substantially axial fluid passages, or a pair of substantially radial fluid passages, and at least one fluid path connecting the first manifold channel and the second manifold channel includes at least one of the substantially azimuthal fluid passages.

In one embodiment, the structure is configured to cool an end turn of a radial-gap electric machine, the end turn having an outer cylindrical surface and an inner cylindrical surface, and the structure includes an outer cooler having an inner cylindrical surface being in thermal contact with the outer cylindrical surface of the end turn, and an inner cooler having an outer cylindrical surface being in thermal contact with the inner cylindrical surface of the end turn.

In one embodiment, the structure includes an outer manifold having a first manifold channel and an inner manifold having a second manifold channel, the first manifold channel being in fluid communication with the fluid channels of the outer cooler, the second manifold channel being in fluid communication with the fluid channels of the inner cooler.

In one embodiment, the opening of the first layer is a hole in the first layer.

In one embodiment, a third layer of the plurality of layers has a third opening forming a portion of a second fluid passage, and a void between the first layer and the third layer forms a third fluid passage connecting the first fluid passage and the second fluid passage, the third fluid passage being substantially parallel to the first layer and the third layer.

According to an embodiment of the present invention there is provided an electric machine including: a stator having an end turn potted in a potting material having a thermal conductivity greater than about 0.4 W/m/° C.; and a cooling structure in thermal contact with the end turn, the cooling structure including a plurality of layers, and a first layer of the plurality of layers having an opening forming a portion of a first fluid passage.

In one embodiment, the electric machine includes a dielectric barrier between the end turn and a layer of the plurality of layers.

According to an embodiment of the present invention there is provided a cooling structure including: a heat transfer structure having a first fluid passage, the cooling structure being configured to cool an end turn of an electric machine having a rotor configured to rotate about an axis, and a portion of the first fluid passage being not parallel to the axis.

In one embodiment, the heat transfer structure further has: a plurality of first apertures; a plurality of second apertures; a second fluid passage having an end at one of the plurality of first apertures; a third fluid passage having an end at one of the plurality of second apertures; and a plurality of fourth fluid passages, the fourth fluid passages connecting the second fluid passage and the third fluid passage.

In one embodiment, the fourth fluid passages have: an interior volume, an interior surface, and a length less than 2 cm, and wherein for each point in the interior volume of the fourth fluid passages, the distance to a nearest point on the interior surface of the fourth fluid passage is less than 1 mm.

In one embodiment, the structure includes: a first manifold having a first manifold fluid channel directly connected to each of the first apertures; and a second manifold having a second manifold fluid channel directly connected to each of the second apertures.

### BRIEF DESCRIPTION OF THE DRAWINGS

These and other features and advantages of the present invention will be appreciated and understood with reference to the specification, claims, and appended drawings wherein:

FIG. 1 is an exploded perspective view of an electric machine stator with a system for end turn cooling, according to an embodiment of the present invention;

FIG. 2 is a schematic cross section of a layered cooling structure, according to an embodiment of the present invention;

FIG. 3 is an exploded perspective view of an electric machine stator with a system for end turn cooling, according to an embodiment of the present invention;

FIG. 4 is a cross sectional view of an electric machine with a system for cooling the rotor, the stator, and the end turns, according to an embodiment of the present invention;

FIG. 5 is an exploded perspective view of two co-wound strips, according to an embodiment of the present invention;

FIG. 6 is an exploded perspective view of an electric machine stator with a system for end turn cooling, according to an embodiment of the present invention;

FIG. 7 is an exploded perspective view of an electric machine stator with a system for end turn cooling, according to an embodiment of the present invention;

FIG. 8 is an exploded perspective view of an electric machine stator for an axial-gap machine, with a system for end turn and stator core cooling, according to an embodiment of the present invention; and

FIG. 9 is a perspective view of a cooling structure for end turn cooling, according to an embodiment of the present invention.

### DETAILED DESCRIPTION

The detailed description set forth below in connection with the appended drawings is intended as a description of exemplary embodiments of an electric machine end turn 106 cooling apparatus provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

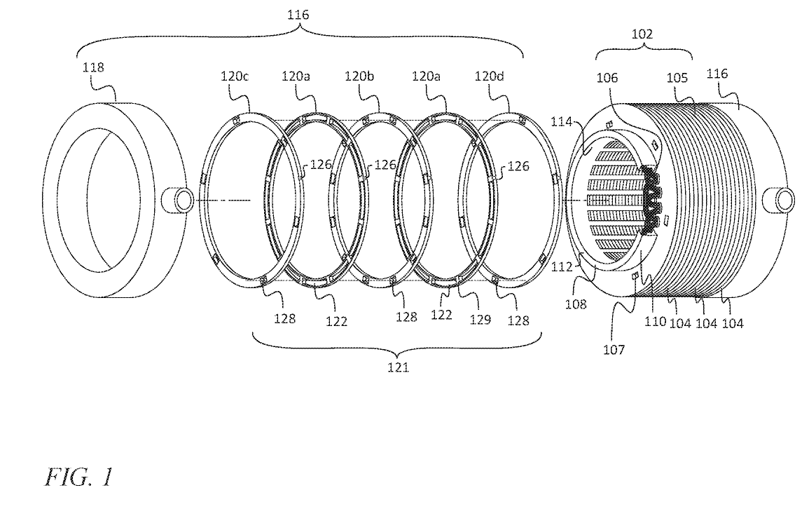

The continuous power rating for electric machines may be determined by the temperature rise of critical elements. In some cases, machine end turns are the first elements to reach critical temperature rise. In these cases, as end turn cooling is improved, the machine continuous power rating may improve, thus providing economic benefit. Referring to FIG. 1, in one embodiment an electric machine stator 102 includes a plurality of stacked stator laminations 104 forming a stator core 105 through which is wound a stator winding having an end turn 106. In some embodiments the stator 102 is formed as a wound strip instead of as a stack of laminations.

Each end turn 106 may include a thermally conductive potting material 108 (e.g., a thermally conductive potting material such as aluminum oxide-filled epoxy or other resin, shown broken away in FIG. 1 to reveal the end turn 106 embedded within it) added to establish a low thermal resistance contact between the end turns 106 and the manifolds. The end turn 106 may be formed such that it has an outer surface in the shape of a circular cylinder, as opposed to having the radial bulge present in some related art end turns 106. The thermally conductive potting resin 108 may be applied under pressure such that it is also forced into the active slot regions where it may help to reduce the thermal resistance between the active part of the winding and the stator core 105. The potted end turn 106 has the shape of a hollow cylinder, or tube, with an outer cylindrical surface 110, an annular end surface 112 and an inner cylindrical surface 114. A cooling structure 116, including a cooling structure housing 118 and a plurality of cooling laminations 120 fits over the outer cylindrical surface 110 of the end turn 106. The cooling structure 116 is assembled with the end turn 106 in a manner insuring good thermal contact between the end turn 106 and the cooling structure 116. For example, the cooling structure 116 may be a tight fit on the potted end turn 106, or the end turn 106 may be potted with the cooling structure 116 in place so that the potting resin 108 is in direct contact with the cooling structure 116. In other embodiments, a thermal grease is used between the cooling structure housing 118 and the end turn 106 to provide good thermal contact. In operation, heat flows from the conductors of the end turn 106 through the potting resin 108 and into the cooling structure 116. Cooling fluid flows through the cooling structure 116, cooling the cooling structure 116, which in turn cools the end turn 106.

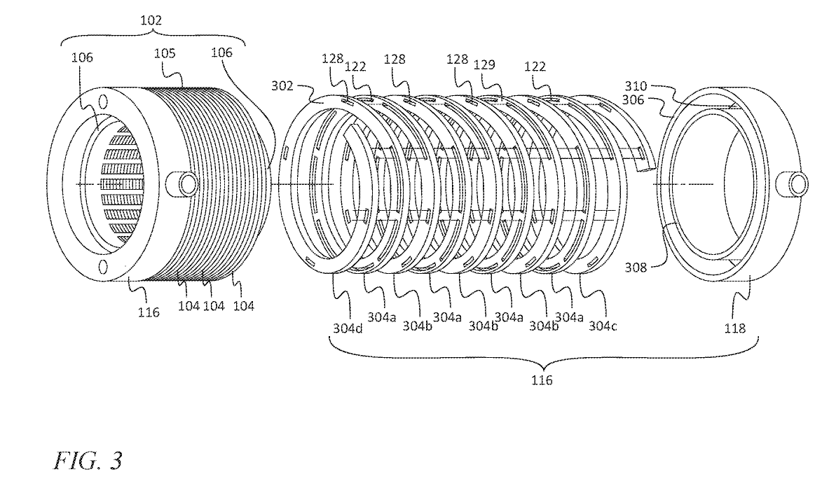

The cooling laminations 120 may be annular elements of four types, referred to as type A laminations 120a, type B laminations 120b, type C laminations 120c and type D laminations 120d (and referred to collectively as cooling laminations 120, which together form a cooling element 121). Each lamination has a plurality of apertures. Each type A lamination has a plurality of wide apertures 122 (e.g., 12 wide apertures 122, as shown in FIG. 1). A web 129 separates each pair of wide apertures 122. Each lamination may also have an alignment notch 126 that engages a corresponding ridge on the interior surface of the outer cylindrical wall of the cooling structure housing 118, to maintain the azimuthal alignment of the cooling laminations 120 with respect to each other. Each type B lamination has a plurality of narrow apertures 128 (e.g., 12 narrow apertures 128, as shown in FIG. 1). Each aperture of each type B lamination 120b straddles a web 129 of an adjacent type A lamination 120a, so that each aperture of each type B lamination 120b overlaps two apertures of the type A lamination 120a. The type C lamination 120c has narrow apertures 128, and may have half as many narrow apertures 128 as a type B lamination 120b. Similarly, the type D lamination 120d also has narrow apertures 128, and may have half as many narrow apertures 128 as a type B lamination 120b. The type C lamination 120c and the type D lamination 120d have different azimuthal orientations (e.g., as a result of the placement of their respective alignment notches), so that each aperture of the type D lamination 120d is not aligned with any aperture of the type C lamination 120c. FIG. 1 illustrates the relative arrangement of elements of one embodiment and is not drawn to scale. Each lamination may have an outer diameter that is a tight fit or an interference fit within the inner diameter of the outer housing wall 306 (FIG. 3) and an inside diameter that is a tight fit, or an interference fit, on the outer diameter of the inner housing wall 308 (FIG. 3). The laminations may then be force fitted into the cooling structure housing 118, securing the laminations in the cooling structure housing 118 and also forming a good thermal contact between, e.g., the inner housing wall 308 and the laminations. One or more registers within the cooling structure housing 118 (e.g., a step in the inside diameter of the outer housing wall 306) may serve as a stop against which the lamination stack may abut during assembly, establishing the axial position of the lamination stack within the cooling structure housing 118. The laminations may also be bonded together, e.g., by applying a suitable bonding agent to the surfaces of the laminations before assembly. In one embodiment, the cooling structure housing 118 and the laminations are both composed of aluminum or of an alloy of aluminum.

For simplicity, only two type A laminations 120a and one type B lamination 120b are shown in FIG. 1. In other embodiments, additional pairs of alternating type A laminations 120a and type B laminations 120b may be included between the type C lamination 120c and the type D lamination 120d. The apertures 128 of the type B laminations 120b then form a plurality of substantially axial fluid passages (e.g., 12 substantially axial fluid passages as shown in FIG. 1). These substantially axial fluid passages may be partially obstructed at each type A lamination 120a by a web 129, which, if the apertures 128 of the type B laminations are significantly wider than the webs 129, may not result in unacceptable head loss. Any two adjacent substantially axial fluid passages are connected by a plurality of substantially azimuthal fluid passages each of which is formed by one of the wide apertures 122 of a type A lamination 120a. In one embodiment, a gap between the stator core 105 and the type D lamination 120d forms a first fluid channel that supplies fluid to half (every other one) of the substantially axial fluid passages through the apertures of the type D lamination 120d. The gap between the stator core 105 and the type D lamination 120d thus forms the fluid channel of an inlet manifold (defined by the outer and inner walls of the cooling structure housing 118, the annular end surface of the stator core 105 and the type D lamination 120d). The same gap may also act as an inlet manifold for the stator core 105, which may also include apertures (e.g., apertures 107) forming fluid channels in the stator core 105 for cooling the stator 102. Further, the cooling structure housing 118 includes a circumferential second fluid channel that receives fluid from half (every other one) of these substantially axial fluid passages through the apertures of the type C lamination 120c. Fluid may flow into the cooling structure housing 118 through a radial housing port 130, and after flowing through the cooling element 121, flow out of the cooling structure housing 118 through two axial end bell ports 132. Flow circuits in an electric machine are described in further detail below. In another embodiment the fluid flows in the opposite direction, and fluid is supplied to the substantially axial fluid passages through the apertures of the type D lamination 120d and received from the substantially axial fluid passages through the apertures of the type C lamination 120c. In other embodiments, a cooling structure 116 may include features different from the laminations 120 to decrease the thermal impedance between a liquid coolant and the cooling structure housing 118. For example fins, e.g., closely spaced fins or “micro-fins”, may be used to increase the internal surface area of the cooling structure housing 118. In some embodiments the cooling structure housing 118 has no additional internal features and the (smooth) internal surface of the cooling structure housing 118 acts as the surface at which heat is transferred from the cooling fluid to the cooling structure 116 (which, in this embodiment, consists simply of the cooling structure housing 118).

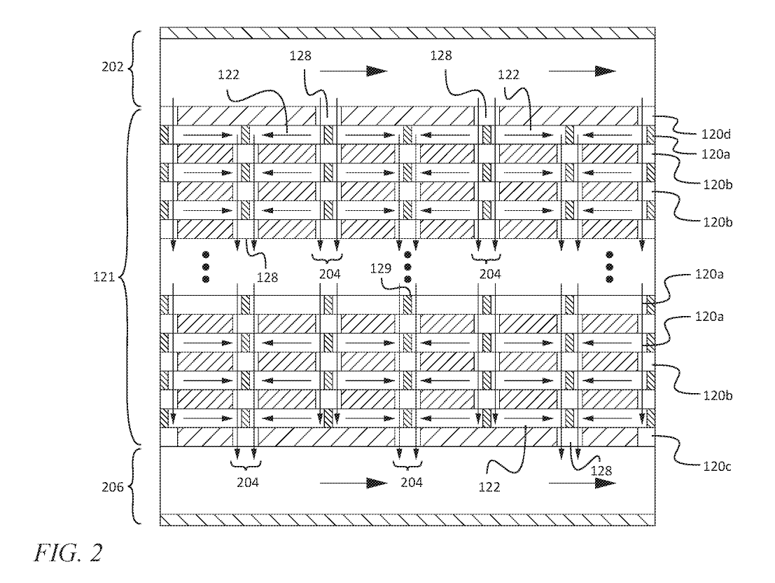

FIG. 2 shows the flow pattern within the cooling structure 116 schematically in one embodiment. The cooling structure of FIG. 2 includes an inlet manifold 202, a cooling element 121, and an outlet manifold 206. The cooling element 121 includes a network of substantially axial fluid passages 204 and substantially azimuthal fluid passages 122 (i.e., each substantially azimuthal fluid passage is formed by a wide aperture 122). The apertures 128 of the type D lamination 120d act as inlet ports to the cooling element 121 and direct the flow from the inlet manifold 202 into a first subset (e.g., half) of the substantially axial fluid passages 204. The apertures 128 of the type C lamination 120c act as outlet ports from the cooling element 121 and direct the flow from a second subset (e.g., the other half) of the substantially axial fluid passages 204 into the outlet manifold 206. Accordingly, the type C lamination 120c and the type D lamination 120d may each be referred to as a flow director. Because each of the substantially axial fluid passages 204 is directly connected only to either the inlet manifold 202 or the outlet manifold 206, each fluid path from the inlet manifold 202 to the outlet manifold 206 includes a substantially azimuthal portion (shown as a horizontal portion in FIG. 2) along one of the substantially azimuthal fluid passages 122 (i.e., within one of the wide apertures 122 of a type A lamination) connecting a first substantially axial portion (shown as a vertical portion in FIG. 2) along one of the first subset of the substantially axial fluid passages 204, and a second substantially axial portion (shown as a vertical portion in FIG. 2) along one of the second subset of the substantially axial fluid passages 204.

The substantially azimuthal fluid passages 122 may have a small axial dimension (e.g., an axial dimension about equal to the thickness of the strip, which may be about 0.2 mm), and as a result the corresponding flow of fluid through the substantially azimuthal fluid passages 122 may result in effective heat transfer between the fluid and the laminations 120. The axial passages 204 need not be strictly axial as illustrated but may for example be helical.

The dimensions of the substantially azimuthal fluid passages may be selected for low thermal impedance between the cooling fluid and the laminated cooling element 121. The finite thermal conductivity of the cooling fluid results in a first component of this thermal impedance (corresponding to heat flow through the coolant) that decreases with decreasing cooling passage width (e.g., decreasing lamination thickness). The finite thermal mass of the coolant results in a second component of the thermal impedance. This second component is inversely proportional to the flow rate, and, for constant head loss, decreases with decreasing cooling passage length (e.g., with decreasing width of the apertures 122 of the type A laminations 120a). Accordingly, the width of the cooling passages may be selected to be a function of coolant pressure (head loss), the length of the cooling passages, the viscosity of the coolant, the specific heat of the coolant, and the thermal conductivity of the coolant. For example, if a low viscosity oil such as transformer oil or automatic transmission fluid (ATF) is used as the cooling fluid, with a head loss on the order of 70 kPa (10 psi), and if the length of the cooling passages is on the order of 1 cm, then a cooling passage width in the range of 0.12 mm to 0.50 mm (0.005″ to 0.020″) may be used. Increasing the number of laminations 120 in the cooling element 121 may reduce the head loss for a given fluid flow rate (because doing so increases the number of azimuthal passages providing parallel flow paths between any pair of axial passages), and also reduces the thermal impedance between the fluid and the cooling element 121, even for constant coolant flow rate.

Referring to FIG. 3, in one embodiment an edge-wound strip 302 is used as the cooling element 121 instead of a stack of laminations. Drawings herein are not to scale, and, for example, the thickness of laminations or of wound strips (e.g., the wound strip of FIG. 3), as well as the dimensions of the cooling structures relative to the end turns, may be exaggerated in the drawings for clarity. The turns 304 of the edge wound strip perform functions similar to those of corresponding laminations in FIG. 1, and either laminations or turns of a wound strip may be referred to herein as “layers”, a term that encompasses both. Type A turns 304a have wide apertures 122 separated by webs 129, type B turns 304b have narrow apertures 128, each straddling two webs 129, each such web 129 being in a respective one of two adjacent type A turns 304a. Type C turns 304c and type D turns 304d act as flow directors. In FIG. 3, the interior structure of the cooling structure housing 118 (which may be similar to the cooling structure housing 118 of the embodiment of FIG. 1) is visible. The cooling structure housing 118 may include an outer housing wall 306, an inner housing wall 308 and an annular housing end wall 310. The outer housing wall 306 and the inner housing wall 308 may abut against the end surface of the stator core 105; a gasket may be installed between the cooling structure housing 118 and the stator core 105 to provide a good fluid seal at this interface. Tie rods (not shown) may be used to draw together the two cooling structure housings 118 to maintain the seal and help lock the cooling structure housings 118 into position.

In operation, cooling fluid may flow in a manner analogous to that of the embodiment of FIGS. 1 and 2. Fluid may flow through an inlet flow director formed by a first turn 304d into a first subset of a set of substantially axial fluid passages (formed by narrow apertures 128 of the type B turns 304b) from which it may flow through a plurality of substantially azimuthal passages 122 into a second subset of the set of substantially axial fluid passages, and through an outlet flow director formed by the last turn 304c. In this manner the turns of the wound strip may be structurally analogous to the laminations of the embodiment of FIGS. 1 and 2.

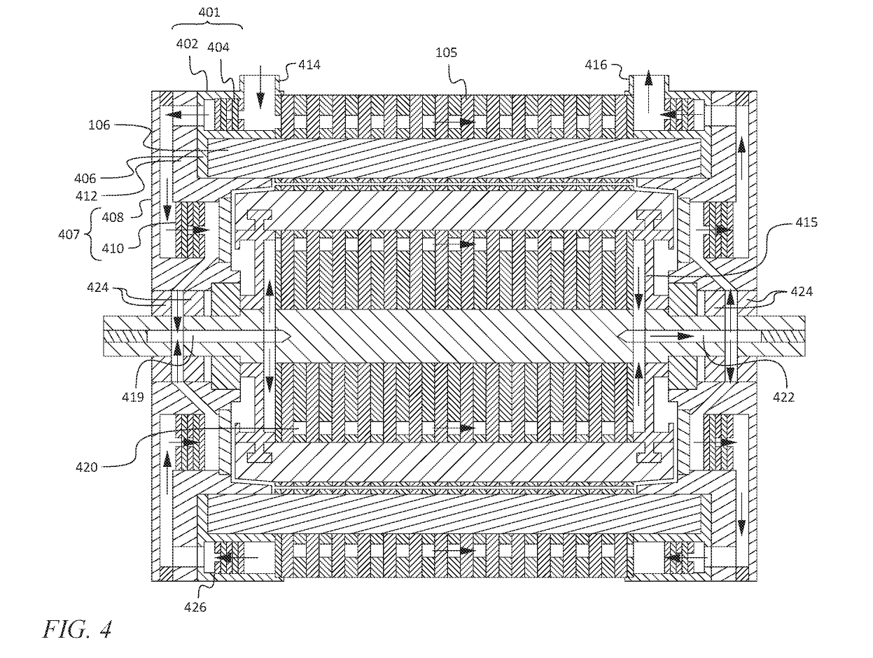

Referring to FIG. 4, in one embodiment a cooling structure cools both the outer cylindrical surface and the inner cylindrical surface of an end turn 106, as well as the annular end surface of the end turn 106. The cooling structure may be employed at both ends of an electric machine to cool both end turns 106, as illustrated in FIG. 4. An outer cooler 401 includes a first cooling structure housing 402 containing a first cooling element 404. The outer cooler 401 cools the outer cylindrical surface of the end turn 106, in a manner similar, for example, to that of the embodiment of FIG. 1. Moreover, a first flange 406 on the first cooling structure housing 402 extends radially inward across, and in thermal contact with, the annular end surface of the end turn 106 to provide cooling of that surface. An inner cooler 407 includes a second cooling structure housing 408, which may be (or may be part of) an end bell 408 (as illustrated in FIG. 4). The second cooling structure housing 408 contains a second cooling element 410, which cools the inner cylindrical surface of the end turn 106 and may include a second flange 412 that extends radially outward across, and is in thermal contact with, an annular surface of the first flange, to provide additional cooling of the annular end surface of the end turn 106.

The electric machine of FIG. 4 may have one coolant inlet 414 (e.g., at the front of the machine) and one coolant outlet 416 (e.g., at the rear of the machine), each connected to two parallel coolant circuits. A first circuit cools the stator core 105. The stator core 105 may have a plurality of laminations with alternating narrow and wide apertures, and one lamination on each end acting as a flow director. This set of laminations may be analogous to the laminations of the cooling element 121 of FIG. 1. In a second parallel circuit, coolant flows, at the front of the machine, through the outer cooler 401, into the end bell 408, and through an inner cooler 407, then through the rotor 415 to the rear of the machine, through an inner cooler 407, through an outer cooler 401, and to the coolant outlet 416. To flow through the rotor the fluid flows through a first rotary fluid coupling into a first axial hole 419 in the rotor shaft, through cooling channels 420 in the rotor to a second axial hole 422 in the rotor shaft, and through a second rotary fluid coupling to the end bell at the rear of the machine. The cooling channels 420 of the rotor 415 may be analogous to those of the stator core 105 and to those of the cooling elements 404, 410, i.e., they may be formed by alternating narrow and wide apertures in the laminations of the rotor. Each rotary fluid coupling may include two rotary seals 424. As mentioned above, the inner surface of the outer housing wall may have a step 426 that acts as a register, so that when the laminations of the cooling element 404 are pressed into the first cooling structure housing 402, they are located axially by abutting against the step 426.

In other embodiments the laminations of the rotor and/or of the stator 102 may be replaced with wound strip structures having alternating narrow and wide apertures 122, in a manner analogous to the substitution of a wound strip in the embodiment of FIG. 3 for the laminations of the embodiment of FIG. 1.

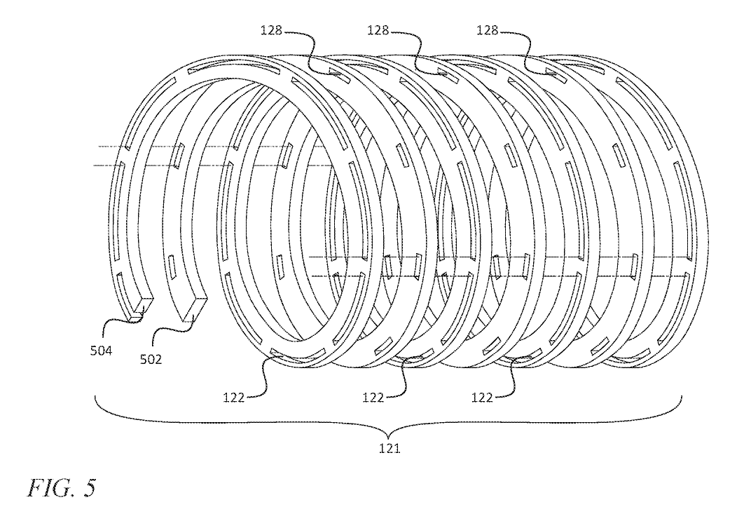

Referring to FIG. 5, in one embodiment two co-wound strips, a first strip 502 having narrow apertures 128 and a second strip 504 having wide apertures 122, may be used instead of a single wound strip with narrow and wide apertures respectively on alternating turns of the wound strip to form a cooling element 121. In such an embodiment the two turns at the ends of the first strip 502 may have fewer apertures (e.g., half as many apertures) as the remaining turns, so that the two turns at the ends of the strip may act as flow directors, or two separate layers, e.g., annular laminations, may be added to the strips 502, 504 to act as flow directors. In another embodiment the first strip 502 may have uniformly spaced apertures along its entire length and it may have one turn more than the second strip 504, so that the turns at both ends of the pair of co-wound strips 502, 504 are both turns of the first strip 502. Two manifolds coupled respectively to the two turns at the ends of the first strip 502 may have features such as bosses or rectangular posts extending into and blocking a subset of the apertures, so that the subset consisting of apertures that are not blocked direct flow into a subset of the substantially axial fluid passages. The combinations of the two turns at the ends of the strip and the features for blocking flow then act as flow directors at the two ends of the cooling element 121.

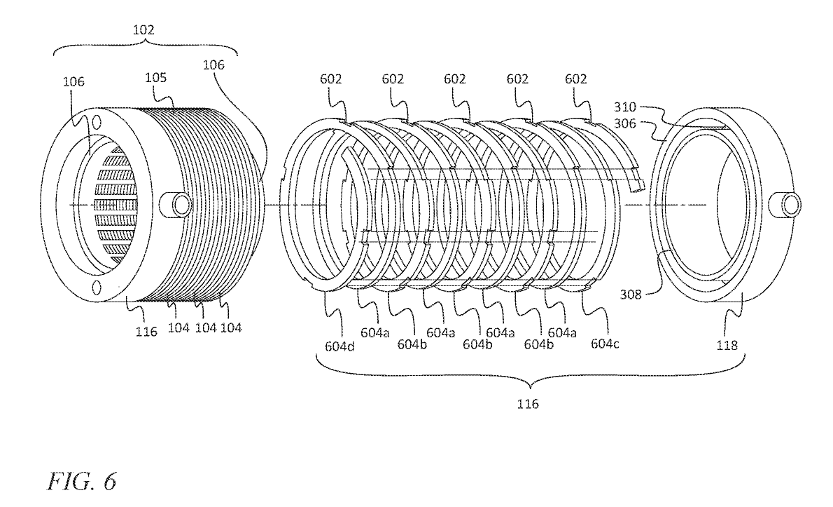

Referring to FIG. 6, in one embodiment, the outer diameter of the wound strip shown in FIG. 3 may be reduced to the point at which the outer diameter breaks into the apertures, i.e., the openings which in the embodiment of FIG. 3 are narrow apertures 128 become openings 602 that are cutouts in the outer edges of the wound strips, each opening 602 being in the shape of a curved rectangle, or a reduction in the outer diameter of the strip along a length of the strip corresponding to the width of the opening. The type A turns 604a (corresponding to turns 304a with wide apertures 122 in the embodiment of FIG. 3) may have a reduced outer diameter. This results in a void between each pair of type B turns, which, together with the inner surface of the outer housing wall 306, forms a set of substantially azimuthal cooling passages, analogous to those of FIGS. 1 and 2. In the embodiment of FIG. 6, substantially axial cooling passages are formed by the inner surface of the outer housing wall 306 together with the narrow openings 602 of type B turns 604b. Type 604c and type 604d turns, together with the inner surface of the outer housing wall 306, act as flow directors, analogous to the flow directors 120c and 120d of FIG. 1. In a related embodiment with co-wound strips, similar that of FIG. 5, a first strip may have openings in its outer diameter and a second strip may have a smaller outer diameter than the first.

In other, analogous embodiments, the inner diameter of the wound strip shown in FIG. 3 may be increased to the point at which the inner diameter breaks into the apertures, and the webs 129 may be omitted. In this case the substantially axial cooling passages are formed by openings that are, instead of being apertures, cutouts on the inner diameter of the wound strip, and the substantially axial fluid passages run along the inside of the wound strip or strips (instead of running along the outside). As in the embodiment of FIG. 6, in this embodiment a void between each pair of type B turns, together with the inner surface of the outer housing wall 306, forms a set of substantially azimuthal cooling passages, analogous to those of FIGS. 1 and 2. Analogous embodiments may be constructed with laminated structures instead of wound strips, e.g., type B laminations may have narrow cutouts in their inner or outer diameters, and type A laminations may have a larger inner diameter or a smaller outer diameter than the type B laminations.

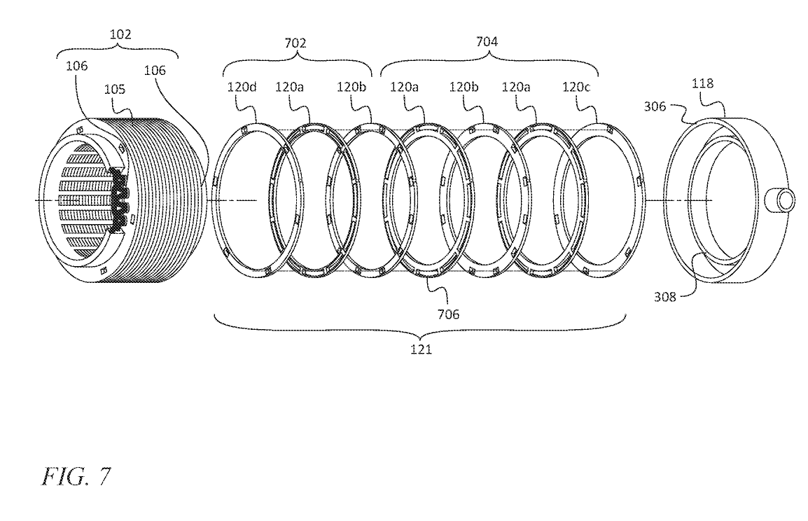

Referring to FIG. 7, in one embodiment some of the laminations of a cooling element 121 may have a reduced inner diameter and may provide additional cooling of the annular end surface of the end turn 106. For example, a first subset 702 of the laminations may have an inner diameter that fits tightly over the end turn 106 (e.g., over the potting resin 108 encapsulating the end turn 106) and a second subset 704 of the laminations may have an inner diameter that fits tightly over the outer surface of the inner housing wall 308. The inner diameter of the inner housing wall 308 may then be the same as the inner diameter of the end turn 106, and the annular end surface of the inner housing wall 308, as well as a portion of a lamination 706, may overlap and abut against the annular end surface of the end turn 106, providing cooling of the end turn 106 through that annular end surface. In other embodiments, the annular end surface may be cooled by a flange (such as the first flange 406 of FIG. 4), and the cooling element may have a sufficiently large number of layers to extend axially past the end of the end turn 106, providing additional cooling to the flange and thereby to the annular end surface of the end turn 106.

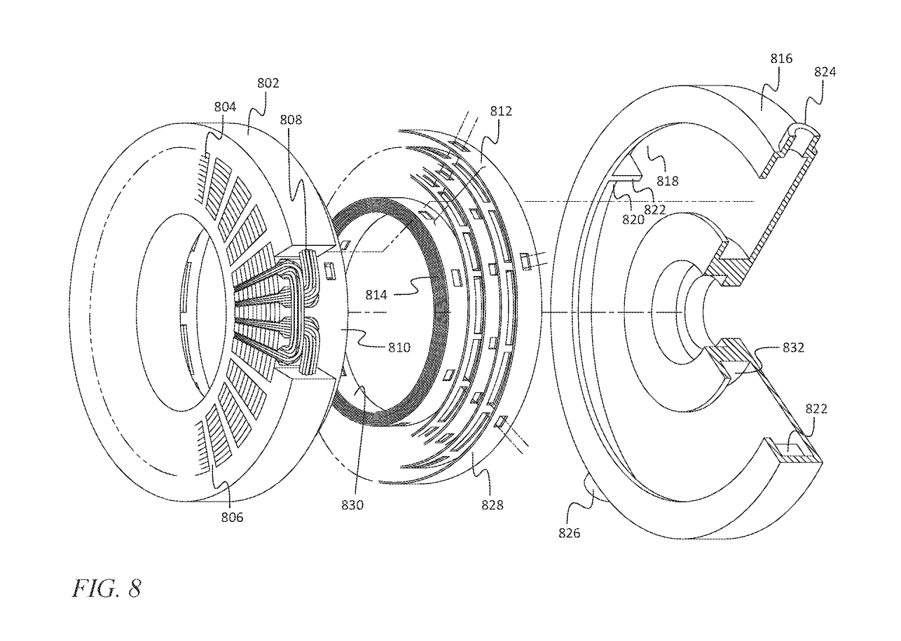

Referring to FIG. 8, in one embodiment, a cooling structure analogous to those described above for a radial gap electric machine may be used with an axial gap electric machine. The stator 802 of an axial gap electric machine may have a stator core 804 formed of cylindrical magnetic laminations, or of a face-wound magnetic strip, with slots 806 in one face for the stator winding 808. The back iron 810 of the stator 802 may contain alternating narrow and wide apertures to provide cooling in a manner analogous to that described for the embodiment of FIGS. 1 and 2. An outer cooling element 812 and an inner cooling element 814 fit tightly over, and inside, the back iron 810 of the stator core 804, respectively. The outer cooling element 812 is illustrated in a breakaway view, and unwound so that apertures that otherwise would be hidden are visible. The layered cooling element consisting of the combined set of layers of the outer cooling element 812, the stator core back iron 810, and the inner cooling element 814 has alternating narrow and wide apertures extending through it, so that, for example, if the innermost layer of the outer cooling element 812 has narrow apertures, the outermost layer of the stator core back iron 810 has wide apertures, or vice versa. As a result the entire layered structure provides fluid flow paths corresponding to those illustrated in FIG. 2, with each substantially radial fluid passage being connected to adjacent substantially radial fluid passages by a plurality of substantially azimuthal fluid passages. A cooling structure housing 816 may include, around the outside of the outer cooling element 812, a first outer fluid channel 818 and a second outer fluid channel 820, separated by two partitions 822. The first outer fluid channel 818 is fed by an inlet port 824 and acts as the fluid channel of an inlet manifold, and the second outer fluid channel 820 is evacuated by an outlet port 826 and acts as the fluid channel of an outlet manifold. The layered cooling element then operates as two semi-annular halves, a first semi-annular half connected to the inlet port 824 and a second semi-annular half connected to the outlet port 826.

Structures analogous to the flow directors 120c and 120d of FIGS. 1 and 2 are formed by layers having fewer apertures than the other layers; e.g., the outermost layer 828 of the outer cooling element 812 acts as both an inlet flow director for the first semi-annular half, and as an outlet flow director for the second semi-annular half. Similarly, the innermost layer of the inner cooling element 814 acts as an outlet flow director for the first semi-annular half, and as an inlet flow director for the second semi-annular half. As used herein, a “flow director” is a structure that allows fluid to flow into, or out of, some, but not all, of the axial passages in a structure having such passages or the radial passages in a structure having such passages.

In the embodiment of FIG. 8, fluid flows inward from the inlet manifold through the first semi-annular half, around an inner fluid channel 832 (formed at the inner diameter of the cooling structure housing 816) to the second semi-annular half, and outward through the second semi-annular half. In particular, in the first semi-annular half the fluid flows inward from the inlet manifold, through the inlet flow director (half of the outermost layer 828) into a first subset (e.g., one half) of the substantially radial fluid passages in the first semi-annular half of the layered cooling element. This fluid then flows through a plurality of substantially azimuthal fluid passages to a second subset of the substantially radial fluid passages in the first semi-annular half, through the innermost turn 830 of the inner cooling element 814 (which acts as an outlet flow director for the first semi-annular half), around the inner fluid channel 832, and through radial and azimuthal fluid passages in the second annular half to the second outer fluid channel 820. The inner fluid channel 832 acts as an outlet manifold for the first annular half and as an inlet manifold for the second annular half of the layered cooling element.

In other embodiments analogous to that of FIG. 6, the layers of the layered cooling element of FIG. 8 may be modified by shifting the apertures of the outer cooling element 812, the stator core back iron 810, and the inner cooling element 814 toward the front of the stator (i.e., to the left as illustrated in FIG. 8) or toward the rear of the stator, until the apertures break through corresponding edges of the outer cooling element 812 and the inner cooling element 814 (and, if the apertures are shifted rearward, of the stator core back iron 810. The narrow apertures then become narrow openings that are rectangular cutouts in the layers (e.g., turns of the wound strips) originally having narrow apertures, and the layers originally having wide apertures become (if the webs 129 are omitted or removed) layers that are narrower than the adjacent layers. The voids between adjacent layers with narrow openings, that result from alternating turns being narrower, then form substantially azimuthal cooling passages.

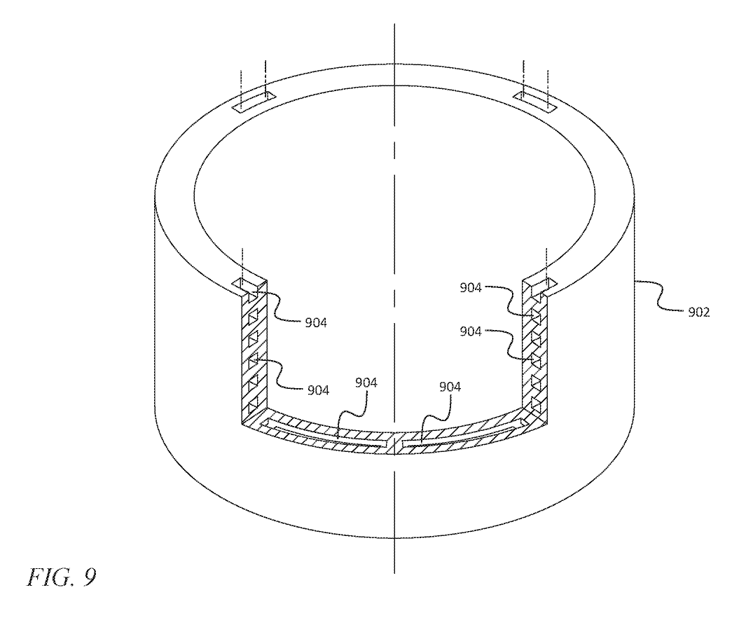

Referring to FIG. 9, in one embodiment a cooling element 902 that is structurally equivalent to a layered structure is formed using a process such as three-dimensional (3D) printing. Such a structure may contain a plurality of cavities 904 analogous to (i.e., arranged in a manner similar to that of) the apertures of the embodiments of FIGS. 1 and 2, forming substantially axial and substantially azimuthal fluid passages, each of the axial fluid passages being connected to adjacent substantially axial fluid channels by a plurality of the substantially azimuthal fluid passages, as in the case of the layered structure of FIG. 1. Similarly, a 3D printed structure may be formed that has a plurality of substantially radial fluid passages, each of which is connected to adjacent substantially radial fluid channels by a plurality of substantially azimuthal fluid passages. Using 3D printing, it may be readily possible to fabricate a structure with passages having a variety of shapes and extending in various directions. In such a structure the benefits of high cooling efficiency may be realized, as in the case of the layered structures described herein, by causing the cooling fluid to flow through a large number of small cooling passages (corresponding, e.g., to the azimuthal fluid passages of the embodiment of FIG. 1). As in the case of a layered structure, good efficiency may be achieved with cooling passages having relatively small transverse dimensions (reducing the component of thermal impedance due to heat flow through the fluid) and having relatively short lengths (reducing the component of thermal impedance due to the finite thermal mass of the coolant).

Although exemplary embodiments of an electric machine end turn 106 cooling apparatus have been specifically described and illustrated herein, many modifications and variations will be apparent to those skilled in the art. Accordingly, it is to be understood that an electric machine end turn cooling apparatus constructed according to principles of this invention may be embodied other than as specifically described herein. The invention is also defined in the following claims, and equivalents thereof.

What is claimed is:

1. A cooling structure comprising:
a plurality of layers,
a first layer of the plurality of layers having an opening forming a portion of a first fluid passage, and
the structure being configured to cool an end turn of an electric machine.

2. The cooling structure of claim 1, wherein each layer is:
a lamination, or
a turn of a wound strip.

3. The structure of claim 1, wherein any layer of the plurality of layers has:
a first opening,
a second opening, and
a third opening,
having the same size and shape, and being uniformly spaced along the layer.

4. The structure of claim 1, wherein:
any layer of the plurality of layers has a first opening and a second opening, the first opening differing in shape and/or in size from the second opening.

5. The structure of claim 1, wherein:
the first layer has a first opening and a second layer of the plurality of layers has a second opening, the first opening differing in shape and/or in size from the second opening.

6. The structure of claim 1, wherein the structure is a hollow cylinder having:
an inner or outer cylindrical surface, and/or an annular end surface, either or both of which are in thermal contact with the end turn.

7. The structure of claim 1, wherein the structure is configured to cool an end turn of an axial gap electric machine.

8. The structure of claim 1, wherein the plurality of layers comprises a wound strip, each of the layers being one of a plurality of turns of the wound strip.

9. The structure of claim 1,
wherein the plurality of layers comprises a first wound strip and a second wound strip, the second wound strip being co-wound with the first wound strip, and
wherein each of the layers is a turn of the first wound strip or of the second wound strip.

10. The structure of claim 1, having a plurality of fluid channels including the opening, the structure further comprising a manifold having a manifold channel in fluid communication with the plurality of fluid channels.

11. The structure of claim 1, having a plurality of fluid channels including the opening, the structure further comprising a flow director configured to direct fluid flow into, or receive fluid flow from, a subset of the plurality of fluid channels.

12. The structure of claim 1, wherein:
the plurality of layers comprises a plurality of alternating different-sized openings.

13. The structure of claim 12, wherein each of the openings overlaps two openings in another layer.

14. The structure of claim 12, having a plurality of fluid channels including the opening, the structure further comprising a flow director configured to direct fluid flow into, or receive fluid flow from, a subset of the plurality of fluid channels.

15. The structure of claim 14, wherein:
the flow director is one of the plurality of layers, and has a plurality of openings of a first size,
wherein:
one of the openings of the flow director is aligned with an opening of the first size of one of the plurality of layers, and
another opening of the first size of the one of the plurality of layers is not aligned with any opening of the flow director.

16. The structure of claim 1, further comprising a first manifold having a first manifold channel and a second manifold having a second manifold channel, wherein:
each of the plurality of layers has a plurality of openings,
the plurality of openings of the plurality of layers forms:
a plurality of substantially azimuthal fluid passages in fluid communication with the first manifold channel and the second manifold channel, and
a plurality of substantially axial fluid passages in fluid communication with the first manifold channel and the second manifold channel, or
a plurality of substantially radial fluid passages in fluid communication with the first manifold channel and the second manifold channel,
each substantially azimuthal fluid passage connects:
a pair of substantially axial fluid passages, or
a pair of substantially radial fluid passages, and
at least one fluid path connecting the first manifold channel and the second manifold channel includes at least one of the substantially azimuthal fluid passages.

17. The structure of claim 1, wherein:
the structure is configured to cool an end turn of an electric machine, the end turn having an outer cylindrical surface and an inner cylindrical surface,
the structure comprises:
an outer cooler having an inner cylindrical surface being in thermal contact with the outer cylindrical surface of the end turn; and
an inner cooler having an outer cylindrical surface being in thermal contact with the inner cylindrical surface of the end turn.

18. The structure of claim 17, wherein the outer cooler has a plurality of fluid channels and the inner cooler has a plurality of fluid channels,
the structure further comprising an outer manifold having a first manifold channel and an inner manifold having a second manifold channel,
the first manifold channel being in fluid communication with the fluid channels of the outer cooler,
the second manifold channel being in fluid communication with the fluid channels of the inner cooler.

19. The structure of claim 1, wherein the opening of the first layer is a hole in the first layer.

20. The structure of claim 1, wherein:
a third layer of the plurality of layers has a third opening forming a portion of a second fluid passage, and
a void between the first layer and the third layer forms a third fluid passage connecting the first fluid passage and the second fluid passage, the third fluid passage being substantially parallel to the first layer and the third layer.

21. An electric machine comprising:
a stator having an end turn potted in a potting material having a thermal conductivity greater than about 0.4 W/m/° C.; and
a cooling structure in thermal contact with the end turn, the cooling structure comprising a plurality of layers, and
a first layer of the plurality of layers having an opening forming a portion of a first fluid passage.

22. The electric machine of claim 21, further comprising a dielectric barrier between the end turn and a layer of the plurality of layers.

23. A cooling structure comprising:
a heat transfer structure having a first fluid passage,
the cooling structure being configured to cool an end turn of an electric machine having a rotor configured to rotate about an axis, and
a portion of the first fluid passage being not parallel to the axis.

24. The cooling structure of claim 23, wherein the heat transfer structure further has:
a plurality of first apertures;
a plurality of second apertures;
a second fluid passage having an end at one of the plurality of first apertures;
a third fluid passage having an end at one of the plurality of second apertures; and
a plurality of fourth fluid passages,
the fourth fluid passages connecting the second fluid passage and the third fluid passage.

25. The cooling structure of claim 24,
wherein the fourth fluid passages have:
an interior volume,
an interior surface, and
a length less than 2 cm, and
wherein for each point in the interior volume of the fourth fluid passages, the distance to a nearest point on the interior surface of the fourth fluid passage is less than 1 mm.

26. The structure of claim 24, further comprising:
a first manifold having a first manifold fluid channel directly connected to each of the first apertures; and
a second manifold having a second manifold fluid channel directly connected to each of the second apertures.

27. A cooling structure comprising:
a plurality of layers, each layer being:
an annular lamination, or
an annular or cylindrical turn of a wound strip;
a first manifold having a first manifold channel; and
a second manifold having a second manifold channel,
each of the plurality of layers having a plurality of openings,
the plurality of openings of the plurality of layers forming:
a plurality of substantially azimuthal fluid passages in fluid communication with the first manifold channel and the second manifold channel, and
a plurality of substantially axial fluid passages in fluid communication with the first manifold channel and the second manifold channel, or
a plurality of substantially radial fluid passages each being in fluid communication with the first manifold channel and the second manifold channel,
each substantially azimuthal fluid passage connecting:
a pair of substantially axial fluid passages, or
a pair of substantially radial fluid passages,
at least one fluid path connecting the first manifold channel and the second manifold channel including at least one of the substantially azimuthal fluid passages, and
the structure being configured to cool an end turn of an electric machine.
